(19) United States
(12) Patent Application Publication
(10) Pub. No.: US 2022/0237918 A1
(43) Pub. Date: Jul. 28, 2022

(54) MONITORING CAMERA AND LEARNING MODEL SETTING SUPPORT SYSTEM

(71) Applicant: PANASONIC I-PRO SENSING SOLUTIONS CO., LTD., Fukuoka (JP)

(72) Inventor: Eisaku MIYATA, Kanagawa (JP)

(73) Assignee: PANASONIC I-PRO SENSING SOLUTIONS CO., LTD., Fukuoka (JP)

(21) Appl. No.: 17/581,195

(22) Filed: Jan. 21, 2022

(30) Foreign Application Priority Data
Jan. 22, 2021 (JP) 2021-008947

(51) Int. Cl. G06V 20/52; G06V 40/16; G06V 40/20

(52) U.S. Cl. CPC G06V 20/52; G06V 40/23; G06V 40/172

(57) ABSTRACT

A monitoring camera is equipped with artificial intelligence. The monitoring camera includes an imaging unit configured to capture an image of a monitoring area, an acquisition unit configured to acquire schedule information indicating a time range in which at least one learning model used for the artificial intelligence that detects an object is validated, a detection unit configured to detect the object from an image captured by the imaging unit based on the learning model, and a processor configured to generate and output an alarm indicating that the object is detected when the object is detected by the detection unit. The processor is configured to switch the learning model based on the schedule information.

### CROSS-REFERENCE TO RELATED APPLICATIONS

This application is based on and claims priority under 35 USC 119 from Japanese Patent Application No. 2021-008947 filed on Jan. 22, 2021, the contents of which are incorporated herein by reference.

### TECHNICAL FIELD

The present disclosure relates to a monitoring camera and a learning model setting support system.

### BACKGROUND ART

Patent Literature 1 discloses a monitoring camera including artificial intelligence. The monitoring camera receives a parameter related to a detection target from a terminal device, constructs artificial intelligence based on the parameter, and uses the constructed artificial intelligence to detect a detection target from an image captured by an imaging unit.

### CITATION LIST

### Patent Literature

Patent Literature 1: JP-2020-113945-A

### SUMMARY OF INVENTION

In Patent Literature 1, a detection target is detected by switching a parameter (for example, an artificial intelligence (AI) learning model for detecting a detection target) set for each detection target. However, since a user who uses the monitoring camera may want to detect different objects or events, there is a demand for using different parameters that can be used in a monitoring camera depending on a time range, and it can be said that there is room for improvement in the usability of the monitoring camera.

An object of the present disclosure is to provide a monitoring camera and a learning model setting support system that can efficiently support the setting of a monitoring camera by a user and can improve usability during an operation of the monitoring camera.

The present disclosure provides a monitoring camera equipped with artificial intelligence. The monitoring camera includes an imaging unit configured to capture an image of a monitoring area, an acquisition unit configured to acquire schedule information indicating a time range in which at least one learning model used for the artificial intelligence that detects an object is validated, a detection unit configured to detect the object from an image captured by the imaging unit based on the learning model, and a processor configured to generate and output an alarm indicating that the object is detected when the object is detected by the detection unit. The processor is configured to switch the learning model based on the schedule information.

Further, the present disclosure provides a learning model setting support system including a terminal device configured to receive a user operation, and at least one monitoring camera that is configured to communicate with the terminal device and to capture an image of a monitoring area, the at least one monitoring camera being equipped with artificial intelligence. The terminal device is configured to generate schedule information indicating information about a time range in which at least one learning model used for the artificial intelligence that detects an object is validated based on the user operation, and to transmit the schedule information to the monitoring camera. The monitoring camera is configured to switch the learning model based on the schedule information, and to generate and output an alarm indicating that the object is detected when the object is detected.

According to the present disclosure, it is possible to efficiently support the setting of a monitoring camera by a user and improve usability during an operation of the monitoring camera.

### BRIEF DESCRIPTION OF DRAWINGS

FIG. 1 is a block diagram showing an example of an internal configuration of a learning model setting support system according to an embodiment.

FIG. 2 is a diagram showing an example of a schedule setting screen of a monitoring camera according to the embodiment.

FIG. 3 is a diagram showing an example of application switching of the monitoring camera.

FIG. 4 is a flowchart showing an example of an operation procedure of the monitoring camera according to the embodiment.

FIG. 5 is a diagram showing an example of an alarm screen.

FIG. 6 is a diagram showing an example of an alarm screen.

### DESCRIPTION OF EMBODIMENTS

Hereinafter, embodiments specifically disclosing a monitoring camera and a learning model setting support system according to the present disclosure will be described in detail with reference to the accompanying drawings as appropriate. Unnecessarily detailed description may be omitted. For example, detailed description of a well-known matter or repeated description of substantially the same configuration may be omitted. This is to avoid unnecessary redundancy in the following description and to facilitate understanding for those skilled in the art. The accompanying drawings and the following description are provided for those skilled in the art to fully understand the present disclosure, and are not intended to limit the subject matter described in the claims.

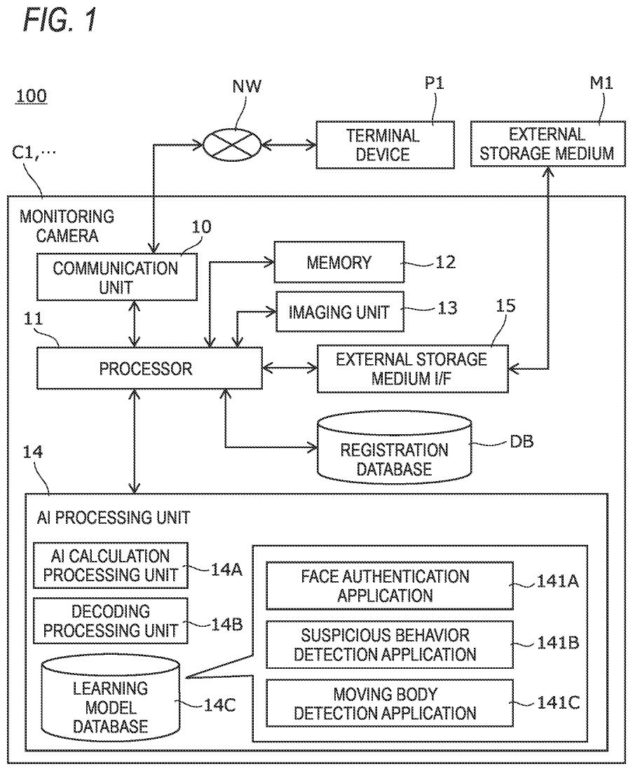

An internal configuration of a learning model setting support system 100 according to an embodiment will be described with reference to FIG. 1. FIG. 1 is a diagram showing an example of an internal configuration of the learning model setting support system 100 according to the embodiment.

The learning model setting support system 100 is a system that can switch an application for detecting a detection target from a monitoring area monitored by at least one monitoring camera C1 according to a day of the week, a time range, or the like. When a user who possesses or uses each of the monitoring cameras C1 operates the terminal device P1, the learning model setting support system 100 receives and sets a schedule setting of an application that detects a detection target for each monitoring camera. The learning model setting support system 100 includes one or more monitoring cameras C1, the terminal device P1, a network NW, and an external storage medium M1. Although only one external storage medium M1 is shown in the example shown in FIG. 1, the learning model setting support system 100 may include a plurality of external storage media M1.

Each of the monitoring cameras C1 in the learning model setting support system 100 is a camera equipped with artificial intelligence (AI), analyzes a captured video (captured image) using an AI learned model, and detects a specific detection target or detection object set by a user. Each of the monitoring cameras C1 is connected to the terminal device P1 via the network NW so that the monitoring camera C1 can execute data communication with the terminal device P1, and the monitoring camera C1 executes an image processing on an image captured by an imaging unit 13 based on various types of setting information that is used for detecting a detection target and is transmitted from the terminal device P1, and detects a detection target.

The various types of setting information referred to here are, for example, information about detection settings such as a detection target (for example, a person, a two-wheel vehicle, a vehicle, and the like), a detection area or a detection line where a detection target is detected, and a detection mode for detecting a detection target in each detection area or each detection line (for example, an intrusion detection of detecting an object that intrudes into a detection area, a stay detection, a direction detection, a line cross detection, and the like), an application for detecting a detection target set in the detection setting, a schedule for validating an application used (validated) in each of the monitoring cameras C1. The detection setting at least includes information about at least one application to be validated. It is needless to say that the various types of setting information are not limited to those described above.

Each of the monitoring cameras C1 includes a communication unit 10, a processor 11, a memory 12, the imaging unit 13, an AI processing unit 14, an external storage medium interface (I/F) 15, and a registration database DB. Although an example is shown in which the registration database DB shown in FIG. 1 is integrally formed with each of the monitoring cameras C1, the registration database DB may be formed separately, or may be formed separately and connected to each of a plurality of monitoring cameras C1 so that the registration database DB can execute data communication with each of the plurality of monitoring cameras C1.

The communication unit 10 serving as an example of an acquisition unit is connected to the terminal device P1 via the network NW so that the communication unit 10 can execute data communication with the terminal device P1. The communication unit 10 may be connected to the terminal device P1 so that the communication unit 10 can execute wired communication, or may be connected to the terminal device P1 via a wireless network such as a wireless LAN. The wireless communication referred to here is, for example, short-range wireless communication such as Bluetooth (registered trademark) or NFC (registered trademark), or communication via a wireless local area network (LAN) such as Wi-Fi (registered trademark).

The communication unit 10 transmits an alarm that is generated by the AI processing unit 14 and indicates that a detection target is detected to the terminal device P1 via the network NW. The communication unit 10 acquires various types of setting information transmitted from the terminal device P1 via the network NW, and outputs the acquired various types of setting information to the processor 11.

The processor 11 is configured with, for example, a central processing unit (CPU) or a field programmable gate array (FPGA), and executes various processings and controls in cooperation with the memory 12. Specifically, the processor 11 achieves a function of each unit by referring to a program and data stored in the memory 12 and executing the program. The function referred to here includes, for example, a function of executing an image processing on a captured image based on various types of setting information, a function of switching an application used by the AI processing unit 14 based on schedule information, a function of generating an alarm for notifying that a detection target is detected based on detection data detected by the AI processing unit 14, and the like.

The processor 11 executes an image processing on an image captured by the imaging unit 13 based on various types of setting information transmitted from the terminal device P1, and outputs a result to the AI processing unit 14. When a control signal or detection data indicating that a detection target is detected is output from the AI processing unit 14, the processor 11 generates an alarm for notifying that a detection target is detected based on the control signal or the detection data. The processor 11 transmits the alarm to the terminal device P1 via the communication unit 10.

The memory 12 includes, for example, a random access memory (RAM) serving as a work memory used when each processing of the processor 11 is executed, and a read only memory (ROM) that stores a program and data for defining an operation of the processor 11. The RAM temporarily stores data or information generated or acquired by the processor 11. A program that defines an operation of the processor 11 is written into the ROM. The memory 12 stores an image captured by the imaging unit 13, various types of setting information transmitted from the terminal device P1, and the like.

The imaging unit 13 includes at least a lens (not shown) and an image sensor (not shown). The image sensor is, for example, a solid-state imaging device such as a charge-coupled device (CCD) or a complementary metal-oxide-semiconductor (CMOS), and converts an optical image formed on an imaging surface into an electric signal. The imaging unit 13 outputs the captured image to the processor 11.

The AI processing unit 14 is configured with, for example, a CPU, a digital signal processor (DSP), or an FPGA, and switches an application to be validated based on schedule information. The AI processing unit 14 executes an image processing and an analysis processing on an image captured by the imaging unit 13 based on learning data corresponding to the validated application. The AI processing unit 14 includes an AI calculation processing unit 14A, a decoding processing unit 14B, and a learning model database 14C.

The AI calculation processing unit 14A serving as an example of a detection unit executes an image processing and an analysis processing on an image captured by the imaging unit 13 based on various types of setting information output from the processor 11 and an application (a learning model) that is stored in the learning model database 14C and is validated by the processor 11. When it is determined that a detection target is detected, the AI calculation processing unit 14A generates detection data related to the detected detection target (for example, a face image or simplified recorded video data of a detected person, a captured image on which a detection frame indicating a position of a detection target is superimposed, and the like). The AI calculation processing unit 14A outputs the generated detection data to the processor 11.

When learning data is transmitted from the terminal device P1, the decoding processing unit 14B decodes the learning data output from the processor 11. The decoding processing unit 14B outputs to and stores the decoded learning data in the learning model database 14C.

The learning model database 14C includes a storage device including one of a semiconductor memory such as a RAM and a ROM and a storage device such as a solid state drive (SSD) or a hard disk drive (HDD). The learning model database 14C generates or stores, for example, a program for defining an image processing to be executed by the AI calculation processing unit 14A and various applications (that is, learning models) used for a detection processing of a detection target executed by the AI calculation processing unit 14A.

The various applications referred to here include a face authentication application 141A that detects each of a plurality of persons registered in the registration database DB by a face authentication processing, a suspicious behavior detection application 141B that detects a predetermined behavior (for example, a behavior that may trigger an incident such as dizziness of a person, quarrel, possession of a pistol, and shoplifting) performed by a person, a moving body detection application 141C that detects a moving body, and the like. The various applications described above are merely examples, and the present invention is not limited thereto. The learning model database 14C may store, for example, an application for detecting a color, a vehicle type, a license plate, or the like of a two-wheel vehicle or a vehicle as another application. The predetermined behavior detected by the suspicious behavior detection application 141B is not limited to those described above.

Learning of generating learning data may be executed using one or more statistical classification techniques. The statistical classification technique includes, for example, linear classifiers, support vector machines, quadratic classifiers, kernel estimation, decision trees, artificial neural networks, Bayesian technologies and/or networks, hidden Markov models, binary classifiers, multi-class classifiers, a clustering technique, a random forest technique, a logistic regression technique, a liner regression technique, a gradient boosting technique, and the like. The statistical classification technique is not limited thereto. The generation of learning data may be executed by the AI processing unit 14 of each of the monitoring cameras C1, or may be executed by, for example, the terminal device P1 that is communicably connected to the monitoring camera C1 using the network NW. Furthermore, the learning data may be received (acquired) from the terminal device P1 via the network NW, or may be received (acquired) from the external storage medium M1 that is communicably connected via the external storage medium I/F 15.

The external storage medium OF 15 is provided such that the external storage medium M1 (for example, a universal serial bus (USB) memory, a secure digital memory (SD) (registered trademark) card, and the like) can be inserted into and removed from the external storage medium I/F 15, and is connected to the external storage medium M1 such that the external storage medium I/F 15 can execute data communication with the external storage medium M1. The external storage medium I/F 15 acquires learning data stored in the external storage medium M1 based on a request from the processor 11, and outputs the learning data to the processor 11. The external storage medium OF 15 transmits data of an image (a video) captured by the imaging unit 13, learning data generated by the AI processing unit 14 of each of the monitoring cameras C1, and the like to the external storage medium M1 and stores the data in the external storage medium M1, based on a request from the processor 11. The external storage medium I/F 15 may be connected to a plurality of external storage media so that the external storage medium OF 15 can execute data communication with the plurality of external storage media at the same time.

The external storage medium M1 is, for example, a storage medium such as a USB memory or an SD (registered trademark) card, and stores an image (a video) captured by the imaging unit 13. The external storage medium M1 may store learning data or the like generated by another monitoring camera or the terminal device P1.

The registration database DB is configured with a storage device including any one of a semiconductor memory such as a RAM and a ROM and a storage device such as an SSD or an HDD. The registration database DB registers (stores) detection target information related to a specific detection target, a captured image of a specific detection target (for example, a face image of a person to be detected, a captured image of a two-wheel vehicle or a vehicle, an image of a license plate, or the like), captured video data of a specific detection target, detection history information in which a specific detection target was detected in the past, and the like. The registration database DB may be configured separately from the plurality of monitoring cameras C1, or may be configured separately from the plurality of monitoring cameras C1 and connected to the plurality of monitoring cameras C1 so that the registration database DB can execute data communication with the plurality of cameras C1.

Although an example is described in the embodiment in which the registration database DB stores (registers) face images of a plurality of persons, the registration database DB is not limited thereto. The registration database DB registers (stores) a captured image or a recorded video used in a detection processing or an authentication processing of a specific detection target (that is, a detection target such as a person, a two-wheel vehicle, and a vehicle designated by a user) detected by an application provided in the AI processing unit 14. For example, the data registered (stored) in the registration database DB may be a captured image of a two-wheel vehicle or a vehicle, a captured image of a license plate of a two-wheel vehicle or a vehicle, a whole body image of a person, or the like. Further, the registration database DB may register (store) information indicating a feature or the like of a detection target (for example, attribute information (gender, height, physique, and the like) of a person, license plate information of a two-wheel vehicle or a vehicle, a vehicle type of a two-wheel vehicle or a vehicle, color information of a two-wheel vehicle or a vehicle, and the like), a past detection history (an alarm history), and the like in association with the registered (stored) captured image or recorded video.

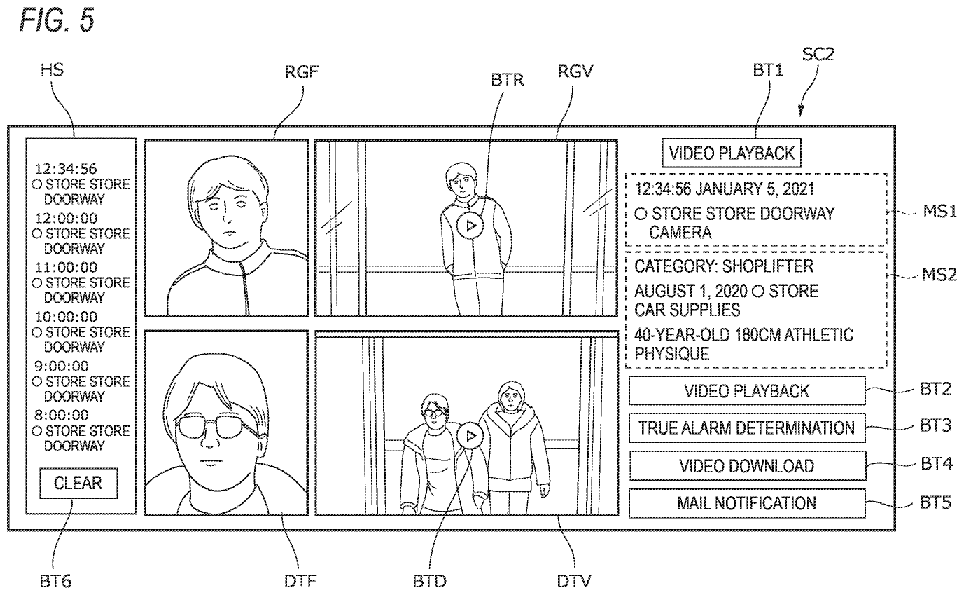

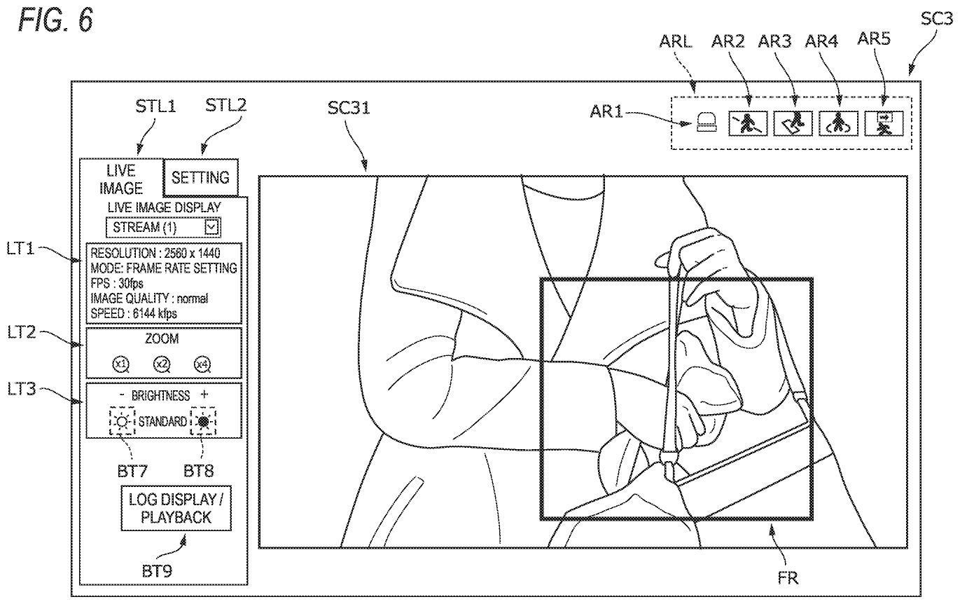

The terminal device P1 is, for example, a device such as a personal computer (PC), a tablet, and a smartphone, and includes an interface (for example, a keyboard, a mouse, or a touch panel display) that can receive an input operation (a user operation) of a user. The terminal device P1 is connected to each of the monitoring cameras C1 via the network NW so that the terminal device P1 can execute data communication with the monitoring cameras C1, and transmits a signal (for example, various types of setting information, learning data, an application, or the like) generated based on a user operation to the monitoring cameras C1 via the network NW. The terminal device P1 generates an alarm screen (for example, alarm screens SC2 and SC3 shown in FIGS. 5 and 6) based on a captured image transmitted from each of the monitoring cameras C1 via the network NW or an alarm transmitted from each of the monitoring cameras C1, and displays the alarm screen on a monitor (not shown).

The network NW is communicably connected to the terminal device P1 and each of the monitoring cameras C1 via a wireless communication network or a wired communication network. The wireless communication network referred to here is provided in accordance with a wireless communication standard such as a wireless LAN, a wireless WAN, a fourth generation mobile communication system (4G), a fifth generation mobile communication system (5G), or Wi-Fi (registered trademark).

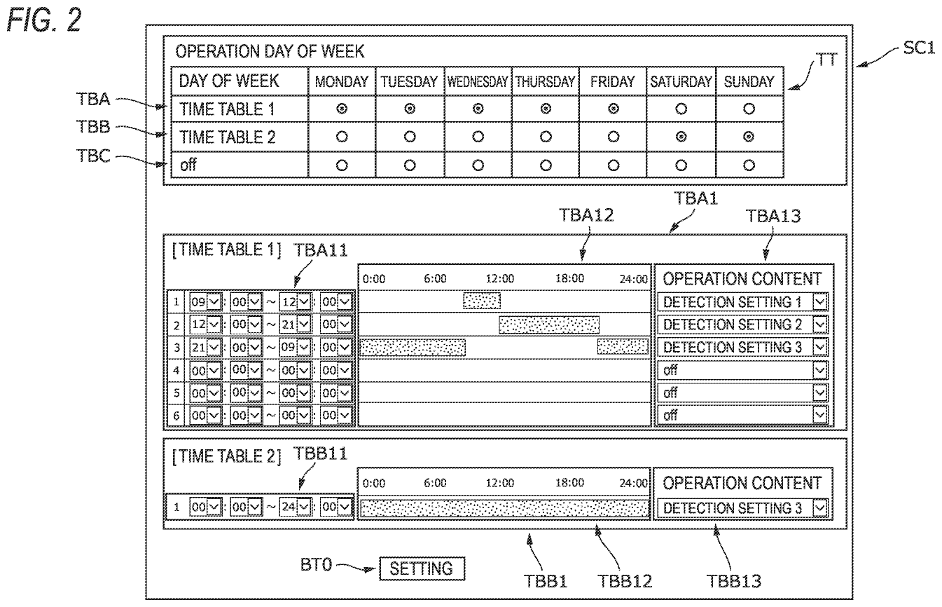

Next, a schedule setting screen SC1 set for each of the monitoring cameras C1 will be described with reference to FIG. 2. FIG. 2 is a diagram showing an example of the schedule setting screen SC1 of the monitoring camera C1 according to the embodiment. The schedule setting screen SC1 shown in FIG. 2 is merely an example, and it is needless to say that the present invention is not limited thereto.

The schedule setting screen SC1 is generated by the terminal device P1, and is output and displayed on a monitor (not shown) provided in the terminal device P1. The schedule setting screen SiC receives a setting operation of a schedule of each of the monitoring cameras C1 from a user who operates the terminal device P1.

The schedule setting screen SC1 includes a time table list TT, detailed setting fields TBA1 and TBB1 of one or more time tables TBA and TBB set in the time table list TT, and a setting button BT0. Although an example of the schedule setting screen SC1 shown in FIG. 2 is described in which two timetables TBA and TBB are set for each of the one or more monitoring cameras C1, the number of time tables to be set is not limited thereto, and the number of time tables may be at least one or more. The schedule set on the schedule setting screen SC1 is set and applied to one or more monitoring cameras designated by a user operation.

The time table list TT includes one or more time tables TBA and TBB set for each of the one or more monitoring cameras C1 designated by a user operation, and an Off table TBC for setting a detection function implemented by each of the monitoring cameras C1 to OFF. The time table list TT receives, from a user, a designation operation of a day of the week for applying a time table (specifically, the time tables TBA, TBB, and the Off table TBC) to each of the one or more monitoring cameras C1. For example, in the time table list TT in the example shown in FIG. 2, the day of the week “Monday, Tuesday, Wednesday, Thursday, Friday” is set in the time table TBA and the day of the week “Saturday, Sunday” is set in the time table TBB for each of the monitoring cameras C1.

The detailed setting fields TBA1 and TBB1 receive a time range designation operation from a user for setting a time range in which a detection setting is set and for setting all applications of the one or more monitoring cameras 1 to an invalidated state (that is, an off state) in the time tables TBA and TBB set in the time table list TT. The detailed setting fields TBA1 and TBB1 respectively include time range designation fields TBA11 and TBB11, detection setting validating time range fields TBA12 and TBB12, and detection setting designation fields TBA13 and TBB13.

The time range designation fields TBA11 and TBB11 receive a designation operation from a user for designating a time range in which each detection setting designated in the detection setting designation fields TBA13 and TBB13 is validated.

The detection setting validating time range fields TBA12 and TBB12 visualize each time range designated in the time range designation fields TBA11 and TBB11. The detection setting validating time range fields TBA12 and TBB12 indicate that the respective detection settings designated in the detection setting designation fields TBA13 and TBB13 by a user operation are validated in the respective time ranges designated in the time range designation fields TBA11 and TBB11.

The detection setting designation fields TBA13 and TBB13 receive a designation operation from a user for designating a detection setting validated in each of the monitoring cameras C1 in each time range designated in the time range designation fields TBA11 and TBB11.

For example, in the example shown in FIG. 2, the time table TBA indicated by a “time table 1” indicates a schedule for validating a detection setting (an application) indicated by operation content “detection setting 1” in a time range “9:00 to 12:00”, validating a detection setting (an application) indicated by operation content “detection setting 2” in a time range “12:00 to 21:00”, and validating a detection setting (an application) indicated by operation content “detection setting 3” in a time range “21:00 to 9:00”. The time table TBB indicated by a “time table 2” indicates a schedule for validating a detection setting (an application) indicated by operation content “detection setting 3” in a time range “00:00 to 24:00”.

The setting button BT0 is a button for setting application schedules that are validated in the time table list TT and one or more time tables TBA and TBB set by a user operation in a predetermined monitoring camera. When the setting button BT0 is selected (pressed) by a user operation, the terminal device P1 generates schedule information based on each time range and detection setting designated in the time table list TT and the one or more time tables TBA and TBB, transmits the schedule information to a monitoring camera designated by a user, and causes the monitoring camera to set the schedule information.

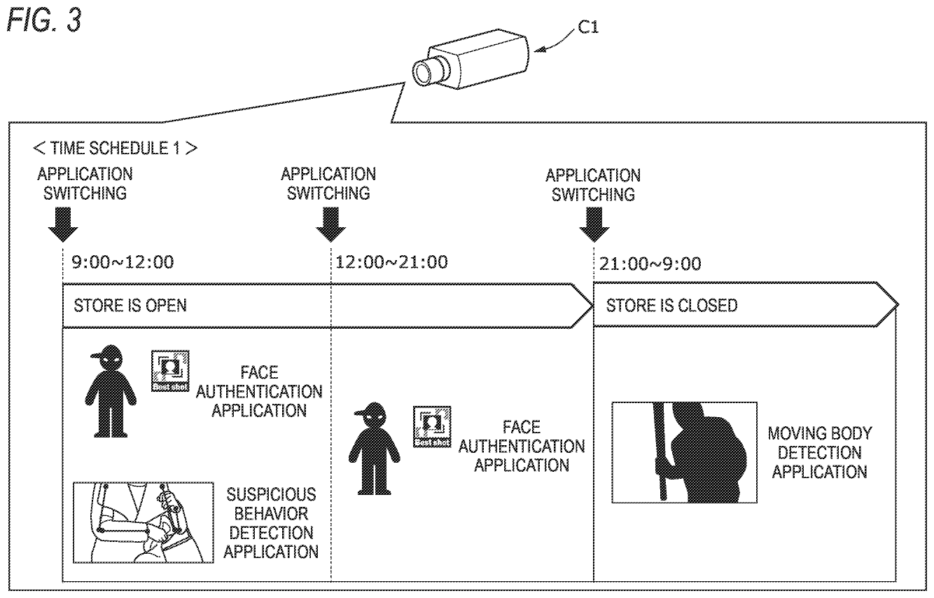

Here, a specific example of application switching of the monitoring camera C1 based on the schedule set on the schedule setting screen SC1 shown in FIG. 2 will be described with reference to FIG. 3. FIG. 3 is a diagram showing an example of application switching of the monitoring camera C1. An installation location of the monitoring camera C1, a monitoring area, and a time table set in the monitoring camera C1 to be described below are merely examples, and it is needless to say that the present invention is not limited thereto. The detection setting to be described below is merely an example, and the present invention is not limited thereto.

The monitoring camera C1 shown in FIG. 3 is, for example, a monitoring camera that captures an image of a doorway of a store, and a schedule set in the “time table 1” set on the schedule setting screen SC1 is set in the monitoring camera C1.

In the example shown in FIG. 3, the “detection setting 1” is a setting in which the face authentication application 141A and the suspicious behavior detection application 141B are validated at the same time in the time range “9:00 to 12:00”. The “detection setting 2” is a setting in which the face authentication application 141A is validated in the time range “12:00 to 21:00”. The “detection setting 3” is a setting in which the moving body detection application 141C is validated in the time range “21:00 to 9:00”.

When it is determined that the current time is “9:00”, the monitoring camera C1 executes an application switching processing of validating the face authentication application 141A and the suspicious behavior detection application 141B at the same time based on the “time table 1”. When it is determined that the current time is “12:00”, the monitoring camera C1 executes an application switching processing of validating the face authentication application 141A based on the “time table 1”. When it is determined that the current time is “21:00”, the monitoring camera C1 executes an application switching processing of validating the moving body detection application 141C based on the “time table 1”.

By setting such a schedule, for example, a user can detect a person who is prohibited from entering and leaving a store using the monitoring camera C1 or can detect whether there is a predetermined behavior (for example, shoplifting, pickpocketing, and the like), for each of a plurality of persons who visit the vicinity of the doorway of the store in the time range “9:00 to 12:00” of a time sale set in the vicinity of the doorway of the store where the monitoring camera C1 is installed. For example, a user can detect a person who is prohibited from entering and leaving the store among a plurality of persons who visit the store using the monitoring camera C1 during the time range “12:00 to 21:00” from when a time sale set in the vicinity of the doorway of the store where the monitoring camera C1 is installed up to when the store is closed, or can detect a person who is about to enter the store during the time range “21:00 to 9:00” from when the store is closed to when the store is opened in the next morning. That is, for example, a user can automatically switch an application used in a detection processing executed by the monitoring camera and an application setting by setting a schedule based on a detection target, a detection condition, or the like desired to be detected by each monitoring camera.

As described above, the learning model setting support system 100 according to the embodiment can support the setting of each of the monitoring cameras C1 by a user on the schedule setting screen SC1, and can improve usability during an operation of each of the monitoring cameras C1.

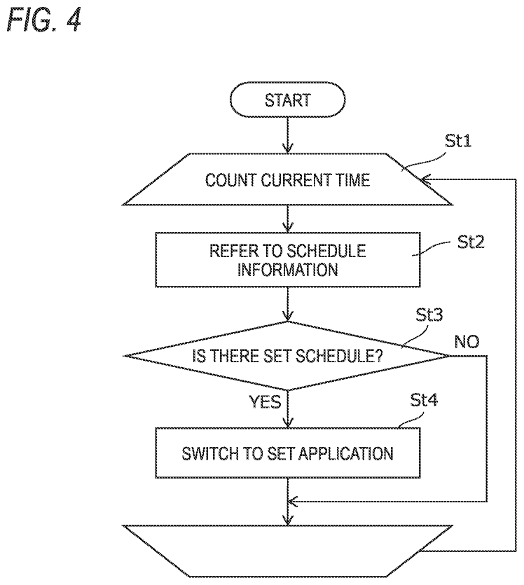

Next, an operation procedure of the monitoring camera C1 according to the embodiment will be described with reference to FIG. 4. FIG. 4 is a flowchart showing an example of an operation procedure of the monitoring camera C1 according to the embodiment.

Each of the monitoring cameras C1 executes switching of an application to be validated based on schedule information transmitted from the terminal device P1 in advance or at any timing.

Each of the monitoring cameras C1 counts the current time (St1) and refers to the schedule information stored in the memory 12 (St2). Each of the monitoring cameras C1 determines whether there is an application to be validated (that is, whether there is a set schedule) at the counted current time based on the schedule information (St3).

When it is determined that there is an application to be validated (that is, there is a set schedule) at the counted current time (St3, YES), each of the monitoring cameras C1 switches to the application based on the schedule information (St4), and starts a detection processing on a detection target based on the application.

In the processing in step St4, when the schedule information is information indicating that a detection target detection function to be executed by a monitoring camera is turned off (that is, all applications are invalidated), each of the monitoring cameras C1 invalidates all applications and returns to the processing in step St1.

On the other hand, when it is determined that there is no application to be validated (that is, there is no set schedule) at the counted current time (St3, NO), each of the monitoring cameras C1 continues the detection processing on the detection target based on the application that is currently validated.

Next, the alarm screen SC2 will be described with reference to FIG. 5. FIG. 5 is a diagram showing an example of the alarm screen SC2 displayed on the terminal device P1. The alarm screen SC2 shown in FIG. 5 is merely an example, and the present invention is not limited thereto. The alarm screen SC2 generated when the face authentication application 141A is validated will be described in the example shown in FIG. 5.

The alarm screen SC2 is generated by the terminal device P1 based on an alarm transmitted from each of the monitoring cameras C1, and is displayed on a monitor (not shown) of the terminal device P1. For example, the alarm screen SC2 shown in FIG. 5 includes a captured image or a recorded video of a person registered in the registration database DB of each of the monitoring cameras C1 in advance as a detection target and a captured image (a face image in the example shown in FIG. 5) or a recorded video of a person captured by each of the monitoring cameras C1, and the person registered as the detection target and the detected person are displayed in a manner in which the person registered as the detection target and the detection person can be compared with each other.

The alarm screen SC2 includes a detection history field HS, a registered face image RGF, a face image DFT, thumbnail images RGV and DTV, video playback buttons BT1 and BT2, a true alarm determination button BT3, a video download button BT4, a mail notification button BT5, detection information MS1, and registration information MS2.

The detection history field HS displays detection date and time information indicating when a person is detected corresponding to each alarm, and monitoring camera information of a monitoring camera that detects a person (for example, area information monitored (captured) by a monitoring camera, a monitoring camera name, an identification number assigned to each monitoring camera, and the like), as detection history information of each alarm transmitted from each of the plurality of monitoring cameras C1. For example, in the detection history field HS shown in FIG. 5, six pieces of detection history information corresponding to respective pieces of alarm notification information are displayed as “12:34:56, ∘store, doorway”, “12:00:00, ∘store, doorway”, “11:00:00, ∘store, doorway”, “10:00:00, ∘store, doorway”, “9:00:00, ∘store, doorway”, and “8:00:00, ∘store, doorway”. In the detection history field HS shown in FIG. 5, the detection history information corresponding to the latest alarm notification information is displayed on an upper side of the drawing, this is merely an example, and the present invention is not limited thereto.

When a user selects (presses) any one of at least one piece of the detection history information displayed in the detection history field HS, the terminal device P1 generates and displays an alarm screen based on an alarm corresponding to the selected (pressed) detection history information. The terminal device P1 highlights the detection history information corresponding to the alarm screen currently displayed on the monitor by a change such as a bold character, a frame line, a character color, and the like. When a clear button BT6 is selected (pressed) by a user operation in a state in which one or more pieces of detection history information in the detection history field HS are selected and operated, the terminal device P1 deletes the detection history information displayed in the detection history field HS.

The face image DFT is a face image of a person captured by each of the plurality of monitoring cameras C1. The registered face image RGF is a face image of a person who is determined to be the same as or similar to a person corresponding to a face image DFT that is registered (stored) in the registration database DB in advance and is captured by each of the plurality of monitoring cameras C1.

The thumbnail image RGV is a thumbnail image of recorded video data of a person of the registered face image RGF that is registered (stored) in the registration database DB in advance. A playback button BTR is superimposed on the thumbnail image RGV. When the video playback button BT1 or the playback button BTR is selected (pressed) by a user operation, the terminal device P1 plays back the recorded video data.

The thumbnail image DTV is a thumbnail image of recorded video data corresponding to the face image DFT that is registered (stored) in the registration database DB in advance and is captured by a monitoring camera. A playback button BTD is superimposed on the thumbnail image DTV. When the video playback button BT2 or the playback button BTD is selected (pressed) by a user operation, the terminal device P1 plays back the recorded video data.

The detection information MS1 includes monitoring camera information “0 store, store doorway camera” of a monitoring camera that captures the face image DFT and imaging date and time information “12:34:56 January 5, 2021”.

The registration information MS2 includes category information “category: shoplifter” of a person corresponding to the registered face image RGF registered (stored) in the registration database DB, imaging date and time information “August 1, 2020” when the registered face image RGF is captured, monitoring camera information “0 store, car supplies” of a monitoring camera, and attribute information “40-year-old, male, 180 cm” and feature information “athletic physique” of a person corresponding to the registered face image RGF registered (stored) in the registration database DB. The registration information MS2 shown in FIG. 5 is merely an example, and the present invention is not limited thereto. For example, the registration information MS2 may only include the imaging date and time information when the registered face image RGF is captured and the monitoring camera information.

The true alarm determination button BT3 is a button for requesting a monitoring camera to generate a video file of a person corresponding to an alarm. When a user determines that an alarm corresponding to the alarm screen SC2 is not a false alarm by visually checking the registered face image RGF, the face image DFT, the recorded video data indicated by the thumbnail image RGV, or the recorded video data indicated by the thumbnail image DTV displayed on the alarm screen SC2, the user selects (presses) the true alarm determination button BT3. When the user selects (presses) the true alarm determination button BT3, the terminal device P1 generates a control command for requesting generation of a video file corresponding to the recorded video data, and transmits the control command to a monitoring camera that is a transmission source of the alarm. Each of the plurality of monitoring cameras C1 generates a video file based on the control command transmitted from the terminal device P1, and then transmits the video file or a URL of the video file to the terminal device P1.

The video download button BT4 is a button for downloading the video file generated by each of the plurality of monitoring cameras C1 into a memory (not shown) of the terminal device P1. When a user selects (presses) the video download button BT4, the terminal device P1 generates and transmits a control command for requesting transmission of the generated video file. The terminal device P1 downloads the video file transmitted from each of the plurality of monitoring cameras C1.

The mail notification button BT5 is a button for transmitting to, a terminal (for example, a smartphone, a tablet terminal, a PC, or the like) registered in advance by a user, a notification mail indicating that an alarm is issued. When a user selects (presses) the mail notification button BT5, the terminal device P1 generates a notification mail including the registered face image RGF, the face image DFT, registered simplified video data indicated by the thumbnail image RGV, simplified recorded video data indicated by the thumbnail image DTV, the detection information MS1, and the registration information MS2, and transmits the notification mail to at least one terminal registered in advance.

When the generation of the video file is completed, the terminal device P1 generates a notification mail including a URL of the video file, or when text data of a feature (for example, clothes, a body shape, an accessory, belongings, or the like) of a person generated by a user operation and text data of a location (for example, position information, area information, and the like of a monitoring camera) of a monitoring camera that finally images (detects) the person are generated, the terminal device P1 generates a notification mail including the generated text data.

Next, the alarm screen SC3 will be described with reference to FIG. 6. FIG. 6 is a diagram showing an example of the alarm screen SC3 displayed on the terminal device P1. The alarm screen SC3 shown in FIG. 6 is merely an example, and the present invention is not limited thereto. The alarm screen SC3 generated when the suspicious behavior detection application 141B is validated will be described in the example shown in FIG. 6.

The alarm screen SC3 is generated by the terminal device P1 based on an alarm transmitted from each of the monitoring cameras C1, and is displayed on a monitor (not shown) of the terminal device P1. For example, the alarm screen SC3 shown in FIG. 6 includes a live video in which a detection frame FR indicating a place where a predetermined behavior is detected is superimposed on a captured video (live video) captured by each of the monitoring cameras C1. The live video may be a detection image in which a detection frame indicating a place where a predetermined behavior is detected is superimposed on a captured image captured by each of the monitoring cameras C1.

The alarm screen SC3 includes a live image field STL1, a setting field STL2, a live video display area SC31, and a detection alarm field ARL.

The live image field STL1 includes various items that can be set related to the display of a live video of a monitoring camera displayed in the current live video display area SC31. The live image field STL1 includes monitoring camera information LT1, a zoom adjustment field LT2, a brightness adjustment field LT3, and a log display and playback button BT9.

The monitoring camera information LT1 indicates information related to a monitoring camera that captures the live video displayed in the live video display area SC31. For example, the monitoring camera information LT1 in the example shown in FIG. 6 indicates resolution information “resolution: 2560×1440” of the monitoring camera that captures the live video displayed in the live video display area SC31, imaging mode information “mode: frame rate designation” set in the monitoring camera, FPS information “FPS: 30 fps”, image quality setting information “image quality: normal”, communication speed information “speed: 6144 kbps”, and the like.

The zoom adjustment field LT2 enlarges or reduces the live video displayed in the live video display area SC31 based on a user operation. When any one of various magnifications (×1, ×2, and ×4 in the example shown in FIG. 6) shown in the zoom adjustment field LT2 is selected (pressed) by a user operation, the terminal device P1 displays the live video displayed in the live video display area SC31 by enlarging or reducing the live video to the selected magnification. The various magnifications shown in FIG. 6 are merely examples, and the present invention is not limited thereto.

The brightness adjustment field LT3 includes a button BT7 for brightening the brightness of the live video displayed in the live video display area SC31 and a button BT8 for darkening the brightness of the live video. The terminal device P1 displays the live video by adjusting (changing) the brightness of the live video displayed in the live video display area SC31 based on a selection (pressing) operation of the button BT7 or the button BT8 by a user.

The log display and playback button BT9 is a button for displaying or playing back a recorded video recorded in a recorder RD. When the log display and playback button BT9 is selected (pressed) by a user operation, the terminal device P1 displays or plays back a recorded video that is captured by a monitoring camera that captures an image of the live video display area SC31 and is recorded in the recorder RD.

When the setting field STL2 is selected by a user operation, the setting field STL2 displays a screen (for example, the schedule setting screen SC1 shown in FIG. 2) that can receive various settings such as the setting of a detection area in which a detection processing is executed by a validated application in each of the monitoring cameras C1, setting of a detection mode detected in each detection area, setting of a detection target (for example, a person, a two-wheel vehicle, a vehicle, or the like), and a schedule setting of each of the monitoring cameras C1. The terminal device P1 stores various types of setting information set by a user operation in a memory (not shown) and transmits the setting information to a monitoring camera designated by a user.

The live video display area SC31 displays a live video of a monitoring camera designated by a user operation. When the AI processing unit 14 detects a detection target, the terminal device P1 displays a live video in which the detection frame FR indicating the detection target is superimposed on the live video. Here, the live video display area SC31 shown in FIG. 6 indicates an example of detecting shoplifting by the suspicious behavior detection application 141B as a predetermined behavior and indicates an example of displaying a live image in which the detection frame FR is superimposed on a portion (area) detected as the predetermined behavior. The detection frame FR may be superimposed by each of the monitoring cameras C1, transmitted to the terminal device P1, and displayed on a monitor (not shown) of the terminal device P1.

The detection alarm field ARL notifies that a detection target is detected by a currently validated application and a detection mode set in the application. The detection alarm field ARL includes, for example, an alarm icon AR1, a line cross icon AR2, an intrusion detection icon AR3, a stay detection icon AR4, a direction detection icon AR5, and the like as one or more icons corresponding to each detection mode.

The alarm icon AR1 is turned on when a detection target is detected in at least one detection mode. When the alarm icon AR1 is selected (pressed) by a user operation in a state where the alarm icon AR1 is turned on, the terminal device P1 cancels alarm states (turn-on states) of all icons in a turn-on state in the detection alarm field ARL and turns off the icons.

The line cross icon AR2 is an icon for notifying that a detection target (for example, a person, a two-wheel vehicle, a vehicle, or the like) passes through a predetermined detection line in a designated direction designated by a user. When it is determined that the detection target entered the predetermined detection line, each of the monitoring cameras C1 generates an alarm including information about a detection mode (here, line cross) and transmits the alarm to the terminal device P1. The terminal device P1 acquires the alarm transmitted from each of the monitoring cameras C1, and turns on the line cross icon AR2 corresponding to the alarm.

The intrusion detection icon AR3 is an icon for notifying that a detection target entered a predetermined detection area set by a user. When it is determined that the detection target entered the predetermined detection area, each of the monitoring cameras C1 generates an alarm including information about a detection mode (here, an intrusion detection) and transmits the alarm to the terminal device P1. The terminal device P1 acquires the alarm transmitted from each of the monitoring cameras C1, and turns on the intrusion detection icon AR3 corresponding to the alarm.

The stay detection icon AR4 is an icon for notifying that a detection target stays in a predetermined detection area set by a user for a certain period of time (for example, 30 seconds, 1 minute, or the like) or more. When it is determined that the detection target stays in the predetermined detection area for a certain period of time or more, each of the monitoring cameras C1 generates an alarm including information about a detection mode (here, a stay detection) and transmits the alarm to the terminal device P1. The terminal device P1 acquires the alarm transmitted from each of the monitoring cameras C1, and turns on the stay detection icon AR4 corresponding to the alarm.

The direction detection icon AR5 is an icon for notifying that a detection target moved in a predetermined designated direction in a predetermined detection area set by a user. When it is determined that the detection target moved in the designated direction in the predetermined detection area, each of the monitoring cameras C1 generates an alarm including information about a detection mode (here, a direction detection) and transmits the alarm to the terminal device P1. The terminal device P1 acquires the alarm transmitted from each of the monitoring cameras C1, and turns on the direction detection icon AR5 corresponding to the alarm.

As described above, each of the monitoring cameras C1 according to the embodiment is a monitoring camera equipped with artificial intelligence. Each of the monitoring cameras C1 includes the imaging unit 13 that captures an image of a monitoring area, the communication unit 10 (an example of an acquisition unit) that acquires schedule information indicating a time range in which at least one learning model (application) used for the artificial intelligence that detects a detection target (an example of an object) is validated, the AI calculation processing unit 14A (an example of a detection unit) that detects a detection target from an image captured by the imaging unit 13 based on the learning model (application), and the processor 11 that generates and outputs an alarm indicating that the detection target is detected when the detection target is detected by the AI calculation processing unit 14A. The processor 11 switches a learning model (an application) based on the schedule information.

Accordingly, each of the monitoring cameras C1 according to the embodiment can set and switch a learning model (an application) validated to detect a detection target according to a time range. Therefore, each of the monitoring cameras C1 can improve usability during an operation of the monitoring camera.

As described above, the schedule information acquired by each of the monitoring cameras C1 according to the embodiment is a schedule for validating a moving body detection application (an example of a moving body detection learning model) that detects a moving body to be detected in a time range of nighttime and validating a face authentication application (an example of a face authentication learning model) that detects a face of a person to be detected in a time range of daytime and that determines whether the detected face of the person matches or is similar to a face image of a person registered in advance. Accordingly, each of monitoring cameras C1 according to the embodiment can switch an application (a learning model) that detects a detection target based on whether the current time is nighttime or daytime, and can detect a moving body in a monitoring area during nighttime and detect a person the same as or similar to each face image of a person registered (stored) in the registration database DB during daytime.

As described above, the schedule information acquired by each of the monitoring cameras C1 according to the embodiment is a schedule for validating the face authentication learning application and a suspicious behavior detection application (an example of a suspicious behavior detection learning model) that detects a behavior of a person to be detected during a time range of daytime and determines whether the detected behavior of the person is a predetermined behavior registered in advance. Accordingly, for example, each of the monitoring cameras C1 according to the embodiment can execute a plurality of applications at the same time during a time range of daytime, and can execute, at the same time, a detection processing of a person the same as or similar to each face image of a person registered (stored) in the registration database DB and a detection processing of a predetermined behavior (for example, a behavior that may trigger an incident such as dizziness of a person, quarrel, possession of a pistol, and shoplifting) performed by each of a plurality of persons that are captured.

As described above, the schedule information acquired by each of the monitoring cameras C1 according to the embodiment is a schedule for validating a moving body detection application (an example of a moving body detection learning model) that detects a moving body to be detected in a time range of nighttime, and validating a suspicious behavior detection application (an example of a suspicious behavior detection learning model) that detects a behavior of a person to be detected in a time range of daytime and that determines whether the detected behavior of the person is a predetermined behavior registered in advance. Accordingly, each of the monitoring cameras C1 according to the embodiment can switch an application that detects a detection target based on whether the current time is nighttime or daytime in each of the monitoring cameras C1, can detect a moving body in a monitoring area during nighttime, and can detect a predetermined behavior (for example, a behavior that may trigger an incident such as dizziness of a person, quarrel, possession of a pistol, and shoplifting) performed by each of a plurality of persons that are captured during daytime.

As described above, the schedule information acquired by each of the monitoring cameras C1 according to the embodiment is a schedule for validating the suspicious behavior detection application and a face authentication application (an example of a face authentication learning model) that detects a face of a person to be detected and determines whether the detected face of the person matches or is similar to a face image of a person registered in advance in a time range of daytime. Accordingly, for example, each of the monitoring cameras C1 according to the embodiment can execute a plurality of applications at the same time during a time range of daytime, and can execute, at the same time, a detection processing of a predetermined behavior (for example, a behavior that may trigger an incident such as dizziness of a person, quarrel, possession of a pistol, and shoplifting) performed by each of a plurality of persons that are captured and a detection processing of a person the same as or similar to each face image of a person registered (stored) in the registration database DB.

As described above, the learning model setting support system 100 according to the embodiment includes the terminal device P1 that can receive a user operation, and at least one monitoring camera C1 that can communicate with the terminal device, that includes artificial intelligence, and that captures an image of a monitoring area. The terminal device P1 generates schedule information indicating information about a time range in which at least one learning model (application) used for artificial intelligence that detects a detection target (an example of an object) is validated based on a user operation, and transmits the schedule information to each of the monitoring cameras C1. Each of the monitoring cameras C1 switches a learning model (an application) based on the transmitted schedule information. When a detection target is detected, each of the monitoring cameras C1 generates and outputs an alarm indicating that the detection target is detected.

Accordingly, the learning model setting support system 100 according to the embodiment can efficiently support the setting of the schedule information indicating a time range of a learning model (an application) used in the artificial intelligence of each of the monitoring cameras C1. The learning model setting support system 100 can switch a learning model (an application) used in the artificial intelligence of each of the monitoring cameras C1 according to a time range, thereby improving usability during an operation of each monitoring camera.

Although various embodiments have been described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Components in various embodiments described above may be combined freely within a range not deviating from the spirit of the invention.

### INDUSTRIAL APPLICABILITY

The present disclosure is useful as a monitoring camera and a learning model setting support system that can efficiently support the setting of a monitoring camera by a user and improve usability during an operation of the monitoring camera.

What is claimed is:

1. A monitoring camera equipped with artificial intelligence, the monitoring camera comprising:
an imaging unit configured to capture an image of a monitoring area;
an acquisition unit configured to acquire schedule information indicating a time range in which at least one learning model used for the artificial intelligence that detects an object is validated;
a detection unit configured to detect the object from an image captured by the imaging unit based on the learning model; and
a processor configured to generate and output an alarm indicating that the object is detected when the object is detected by the detection unit,
wherein the processor is configured to switch the learning model based on the schedule information.

2. The monitoring camera according to claim 1,
wherein the schedule information is a schedule for validating a moving body detection learning model that detects a moving body serving as the object in a time range of nighttime, and validating a face authentication learning model that detects a face of a person serving as the object in a time range of daytime and determines whether the detected face of the person is the same as or similar to a face image of a person registered in advance.

3. The monitoring camera according to claim 2,
wherein the schedule information is a schedule for validating the face authentication learning model and a suspicious behavior detection learning model that detects a behavior of a person serving as the object in the time range of daytime and determines whether or not the detected behavior of the person is a predetermined behavior registered in advance.

4. The monitoring camera according to claim 1,
wherein the schedule information is a schedule for validating a moving body detection learning model that detects a moving body serving as the object in a time range of nighttime, and validating a suspicious behavior detection learning model that detects a behavior of a person serving as the object in a time range of daytime and determines whether or not the detected behavior of the person is a predetermined behavior registered in advance.

5. The monitoring camera according to claim 4,
wherein the schedule information is a schedule for validating the suspicious behavior detection learning model and a face authentication learning model that detects a face of a person serving as the object in the time range of daytime and determines whether the detected face of the person is the same as or similar to a face image of a person registered in advance.

6. A learning model setting support system comprising:
a terminal device configured to receive a user operation; and
at least one monitoring camera that is configured to communicate with the terminal device and to capture an image of a monitoring area, the at least one monitoring camera being equipped with artificial intelligence,
wherein the terminal device is configured to generate schedule information indicating information about a time range in which at least one learning model used for the artificial intelligence that detects an object is validated based on the user operation, and to transmit the schedule information to the monitoring camera, and
wherein the monitoring camera is configured to switch the learning model based on the schedule information, and to generate and output an alarm indicating that the object is detected when the object is detected.
